(19) United States
(12) Patent Application Publication
(10) Pub. No.: US 2024/0405285 A1
(43) Pub. Date: Dec. 5, 2024

(54) Failsafe Liquefied Gas Electrolytes with Solidifying Agents

(71) Applicant: SOUTH 8 TECHNOLOGIES, INC., San Diego, CA (US)

(72) Inventors: Frederick Krause, Carlsbad, CA (US); Cyrus Rustomji, San Diego, CA (US); Jungwoo Lee, San Diego, CA (US); Jeremy Intrator, San Diego, CA (US)

(21) Appl. No.: 18/680,157

(22) Filed: May 31, 2024

Related U.S. Application Data
(60) Provisional application No. 63/470,174, filed on May 31, 2023.

(51) Int. Cl. H01M 10/0569; H01G 9/035; H01M 10/0525; H01M 10/0567; H01M 10/0568

(52) U.S. Cl. CPC H01M 10/0569; H01M 10/0525; H01M 10/0567; H01M 10/0568; H01G 9/035; H01M 2300/0034; H01M 2300/0037

(57) ABSTRACT

An ionically conducting electrolyte is disclosed that includes a mixture of a liquefied gas solvent, a solidifying agent, and a salt. The liquefied gas solvent has a vapor pressure above 100 kPa at 293.15K. The solidifying agent may be a solid, liquid, or a gas at 100 kPa and 293.15K. The salt is soluble in the ionically conducting electrolyte at 100 kPa and 293.15K, thereby maintaining the ionically conducting electrolyte in a liquid phase. The salt and solidifying agent create a solid material at 100 kPa and 293.15K when the liquified gas solvent is removed from the mixture. Also disclosed are electrochemical devices including two electrodes in contact with this electrolyte. The device has a housing enclosing the electrolyte and electrode.

### CROSS-REFERENCE TO RELATED APPLICATIONS

This application claims priority to U.S. Application 63/470,174 filed on May 31, 1923, all the contents of which are incorporated by reference.

This application is related to the following applications and patents, each of which is hereby incorporated by reference in its entirety: U.S. Pat. No. 10,608,284 issued on Mar. 31, 1920; U.S. Pat. No. 10,998,143 issued on May 4, 1921; U.S. Pat. No. 10,784,532 issued on Sep. 22, 1920; U.S. Pat. No. 11,088,396 issued Aug. 10, 1921; U.S. Pat. No. 10,873,070 issued on Dec. 22, 2020; U.S. Pat. No. 11,342,615 issued on May 24, 1922; PCT/US20/26086 filed on Apr. 1, 2020; PCT/US22/31594 filed on May 31, 1922; PCT/US23/11864 filed on Jan. 30, 1923; PCT/US23/17720 filed on Apr. 6, 2023; PCT/US23/28104 filed on Jul. 19, 1923; PCT/US23/28105 filed on Jul. 19, 1923; PCT/US23/35766 filed on Oct. 24, 1923; PCT/US24/16784 filed on Feb. 21, 1923; PCT/US24/18746 filed on Mar. 6, 1924; PCT/US24/16784 filed on Feb. 21, 1924; PCT/US24/25771 filed on Apr. 23, 1924; U.S. Application 63/418,703 filed on Oct. 24, 1922; U.S. Application 63/461,252 filed on Apr. 22, 1923; U.S. Application 63/461,387 filed on Apr. 24, 1923; U.S. Application 63/470,174 filed on May 31, 1923; U.S. Application 63/534,213 filed on Aug. 22, 1923; U.S. Application 63/450,745 filed on Mar. 8, 1923; U.S. Application 63/652,616 filed on May 28, 1924 and U.S. application Ser. No. 18/676,507 filed on May 29, 1924.

### FIELD OF THE INVENTION

Embodiments of the invention relate to compositions and to the chemical formulations of electrolytes for use in electrochemical energy devices, such as batteries and electrochemical capacitors.

### BACKGROUND OF THE INVENTION

Electrochemical devices, such batteries or capacitors, employ ionically conducting, electrically insulating electrolytes to carry charge between a negative and positive electrode. These electrolytes are typically liquid at room temperature and atmospheric pressure (at 100 kPa and 293.15K, “standard conditions”) and consist of an approximately 1.0 M (moles per liter) salt in solvent mixture and optional additives which may be solid, liquid, or gaseous under standard conditions. Salt and solvent molecules exist in so called “solvation shells” where positive and negative ions are typically surrounded by solvent, additive and other positive and negative ions. These solvation shells affect all aspects of the device, from cyclability to safety and depend on concentrations and compositions of the electrolyte formulations.

An electrochemical device typically consists of two electrodes separated by a separator material either in a planar stack or spiral wound configuration; a liquid electrolyte that saturates the electrodes and separator material, providing ionic conductivity between the two electrodes necessary for charging and discharging. In the case of damage or defect within the device, thermal runaway is usually precipitated by some form of short circuit between the two electrodes, either internal or external. In both cases, the electrodes are rapidly discharged by the circuit comprised of the shorting defect, the electrodes, and the electrolyte. In current devices using liquid electrolytes, when the device is punctured or damaged the electrolyte remains trapped in the separator and electrodes and maintains conductivity between the electrodes, resulting in an uncontrolled discharge and thermal runaway. This is extremely dangerous.

What is needed is a device that is safe when punctured or damaged, a device that does not experience thermal runaway.

### SUMMARY OF THE INVENTION

An ionically conducting electrolyte that overcomes thermal runaway is disclosed. The electrolyte includes a mixture of a liquefied gas solvent, a solidifying agent, and a salt. The liquefied gas solvent has a vapor pressure above 100 kPa at 293.15K. The solidifying agent may be a solid, liquid, or a gas at 100 kPa and 293.15K. The salt is soluble in the ionically conducting electrolyte at 100 kPa and 293.15K, thereby maintaining the ionically conducting electrolyte in a liquid phase. The salt and solidifying agent create a solid material at 100 kPa and 293.15K when the liquified gas solvent is removed from the mixture. Also disclosed are electrochemical devices that implement this novel electrolyte.

When an electrochemical device is filled with the novel electrolytes disclosed herein, the pressurized liquid solution saturates the electrodes and separator materials as in the traditional liquid electrolyte's case. Within the device, the solidifying agent is dissolved within the liquefied gas electrolyte solution. If the housing's seal is broken due to damage or defect, the liquefied gas solvent components of the electrolyte vaporize and vacate the device; the solidifying agent and salt components remain inside the housing. In the absence of the liquefied gas solvent components, the solidifying agent and salt components co-precipitate as solid materials within the separator and electrodes, replacing the ionically conducting electrolyte with a material which is solid at 100 kPa and 293.15K and has a very low ionic conductivity or is non ionically conducting. This loss of conductivity terminates the short circuit discharge before thermal runaway can occur, resulting in a safer device.

Additional aspects, alternatives and variations, as would be apparent to persons of skill in the art, are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### BRIEF DESCRIPTION OF THE DRAWINGS

The invention can be better understood with reference to the following figures. The components within the figures are not necessarily to scale, emphasis instead being placed on clearly illustrating example aspects of the invention. In the figures, like reference numerals designate corresponding parts throughout the different views and/or embodiments. Furthermore, various features of different disclosed embodiments can be combined to form additional embodiments, which are part of this disclosure. It will be understood that certain components and details may not appear in the figures to assist in more clearly describing the invention.

FIG. 1 is a Raman spectrum of the dry solid after venting compared to LiTFSI and DME.

FIG. 2 is a Raman spectrum of the dry solid after venting compared to 1:3 LiTFSI:DME, LiTFSI and DME.

FIG. 3 is a Raman spectrum illustrating the shift of the TFSI anion relative to the 1:3 LiTFSI:DME material.

### DETAILED DESCRIPTION OF THE INVENTION

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention, as defined by the appended claims.

In the following description, numerous specific details are set forth to provide a thorough understanding of the present invention. Example embodiments of the present invention may be implemented without some or all these specific details. In other instances, process operations well known to persons of skill in the art have not been described in detail in order not to obscure unnecessarily the present invention. Various techniques and mechanisms of the present invention will sometimes be described in singular form for clarity. However, it should be noted that some embodiments include multiple iterations of a technique or multiple mechanisms, unless noted otherwise. Similarly, various steps of the methods shown and described herein are not necessarily performed in the order indicated, or performed at all in certain embodiments. Accordingly, some implementations of the methods discussed herein may include more or fewer steps than those shown or described. Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection, unless otherwise noted.

It is known that liquefied gas electrolytes can improve the performance of electrochemical devices through higher power, higher energy, temperature performance, or safety. However, some liquefied gas solvent, additive and salt mixtures, when vented from an electrochemical device, leave behind a small amount of residual liquid electrolyte within the separator and electrodes. Typical abuse or defect conditions with which electrochemical device designs are concerned include overheating, overcharging, external short circuit, internal short circuit due to material defect, and internal short circuit due to crushing or nail penetration. In each of these cases, heat and pressure build up within the electrochemical device until a vent is activated or the housing bursts. In the case of short circuits, the shorting path enables a low-resistance uncontrolled discharge which causes the cell to generate heat, eventually causing the combustion of chemical components releasing in more heat and causing thermal runaway. To cause this uncontrolled discharge, a complete circuit is required, which depends on the ionic conductivity of the electrolyte. With conventional liquid electrolytes, none of these abuse conditions compromise the integrity or conductivity of the electrolyte, allowing a defect or abuse condition to induce thermal runaway.

It has been determined through considerable experimentation that certain electrolyte components, referred to herein as solidifying agents, which exist in solution as part of a liquefied gas electrolyte mixture, can precipitate when the liquefied gas components of such an electrolyte are removed from the electrolyte mixture. It is also found that certain formulations of liquefied gas electrolytes, when an electrochemical device vent is activated, can immediately vacate the cells of the liquefied gas solvent components while leaving behind in the cell the salt and solidifying agent components. This can be induced by heating the cell or overcharging the cell, both of which raise the cell's internal pressure and actuate the venting mechanism. This can also be induced by an external or internal short circuit, which will raise the internal pressure to the venting point in the same way. This can also be induced by physical damage to the cell such as crushing or nail penetration, which causes evacuation of the liquefied gases not through the dedicated vent but through the damaged area of the can. It is further found that the addition of solidifying agents to the liquefied gas electrolyte results in precipitation of both solidifying agent and salt during this process which dramatically increases the internal resistance of the electrode stack and effectively shuts down discharging processes by creating a highly resistive solid material within the separator between the electrodes. It is further found that this increase in resistance is greater and faster when solidifying agent components are included in the electrolyte mixture than when liquefied gas electrolytes without these components are used in the same situations.

One embodiment is an electrochemical device comprising an ionically conducting electrolyte. The ionically conducting electrolyte may comprise one or more salts, one or more liquefied gas solvents, one or more solidifying agents, and zero, one, or more additives. The one or more salts may be liquid, solid, or gas at 100 kPa and 293.15K. The liquefied gas solvent is gaseous at 100 kPa and 293.15K. The solidifying agent is solid, liquid, or gas at 100 kPa and 293.15K. The one or more additives may be liquid, solid, or gas at 100 kPa and 293.15K.

Some such embodiments of electrochemical devices may further comprise a housing, enclosing the ionically conducting electrolyte and structured to provide a hermetically sealed condition to the one or more salts and to the solution of one or more solvents, such as liquefied gas solvents and solidifying agents, and a pair of electrodes in contact with the ionically conducting electrolyte.

One embodiment is an electrochemical device where the liquefied gas electrolyte is comprised of liquefied gas solvents such as fluoromethane, difluoromethane, trifluoromethane, fluoroethane, tetrafluoroethane, pentafluoroethane, 1,1-difluoroethane, 1,2-difluoroethane, 1,1,1-trifluoroethane, 1,1,2-trifluoroethane, 1,1,1,2-tetrafluoroethane, 1,1,2,2-tetrafluoroethane, pentafluoroethane, chloromethane, chloroethane, thionyl fluoride, thionyl chloride fluoride, phosphoryl fluoride, phosphoryl chloride fluoride, sulfuryl fluoride, sulfuryl chloride fluoride, 1-fluoropropane, 2-fluoropropane, 1,1-difluoropropane, 1,2-difluoropropane, 2,2-fluoropropane, 1,1,1-trifluoropropane, 1,1,2-trifluoropropane, 1,2,2-trifluoropropane, fluoroethylene, cis-1,2-fluoroethylene, 1,1-fluoroethylene, 1-fluoropropylene, 2-propylene, chlorine, chloromethane, bromine, iodine, ammonia, methyl amine, dimethyl amine, trimethyl amine, molecular oxygen, molecular nitrogen, carbon monoxide, carbon dioxide, sulfur dioxide, dimethyl ether, methyl ethyl ether, methyl vinyl ether, difluoro ethylene, nitrous oxide, nitrogen dioxide, nitrogen oxide, carbon disulfide, hydrogen fluoride, hydrogen chloride or any combination thereof. In some embodiments, the liquefied gas solvents can be difluoromethane. In some embodiments, the liquefied gas solvent can be chloromethane. In some embodiments, the liquefied gas solvent can be fluoromethane. In some embodiments, the liquefied gas solvent can be 1,1-difluoroethane. In some embodiments, the liquefied gas solvent can be sulfuryl fluoride. In some embodiments, the liquefied gas solvent can be thionyl chloride or thionyl fluoride. In some embodiments, the liquefied gas solvent can be selected from the group consisting of: fluoromethane, difluoromethane, sulfuryl fluoride, chloromethane, carbon dioxide, 1,1-difluoroethane and any combination thereof. In some embodiments, the liquefied gas electrolyte includes a single liquefied gas solvent or a combination of liquefied gas solvent and one or more additives and/or one or more salts. These additives may be gaseous, liquid or solid at 100 kPa and 293.15K. Further, any of the gaseous additives may also be used as a primary solvent.

In some embodiments, the liquefied gas electrolyte is further comprised of solidifying agents that are solids at 100 kPa and 293.15K such as dimethoxyethane, bis(2-methoxyethyl)ether, 1,2-bis(2-methoxyethoxy)ethane, 12-crown-4, 15-cown-5, 18-crown-6, diphenyl sulfone, bis(4-fluorophenyl) sulfone, dimethyl sulfone, ethyl methyl sulfone, butadiene sulfone, 1,3-propanesultone, 1-propene-1,3-sultone, 2-bornanone, 2,3-borananedione, 2-norbornanone, triphenyl phosphate, ethylene carbonate, or any combination thereof. It is found through considerable experimentation that these solidifying agents bind to the lithium ion within the electrolyte solution strongly. When in the complete liquefied gas mixture, the salt and solidifying agents exist in the liquid phase. When vented, the liquefied gas components may be released from the solution and the solidifying agents remain strongly coordinated to the lithium ion and the salt anion. This strong coordination creates a solid material when the liquefied gas components are released.

While it has previously been shown that gas, liquid, or solid additives may be used within a liquefied gas electrolyte to coordinate to the salt to create highly conductive solutions, it has never been shown before that, with the appropriate selection of chemical components, these gas or liquid additives may solidify after the liquefied gas solvent is vented from the electrolyte. This phase change behavior of the solidifying agents is a unique discovery which can help improve the safety of an electrochemical device.

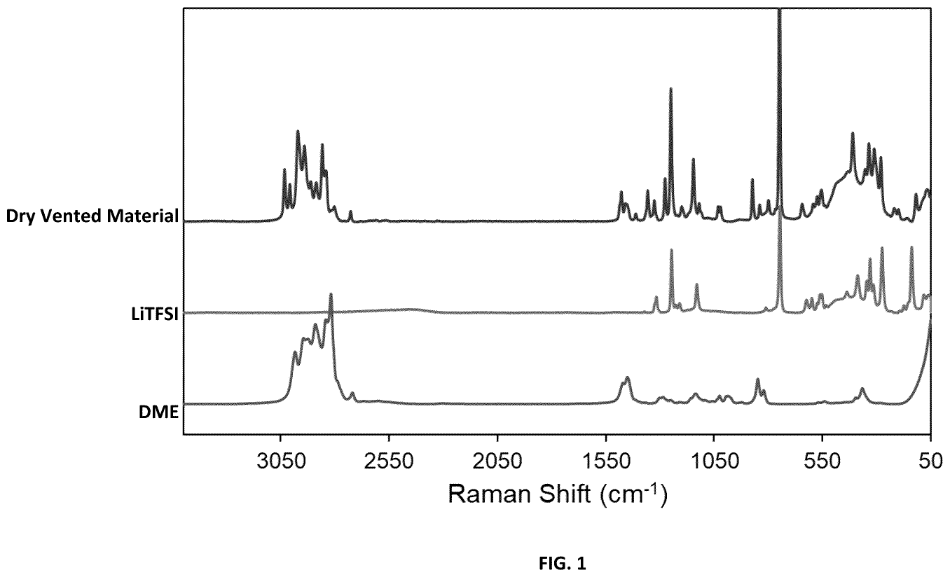

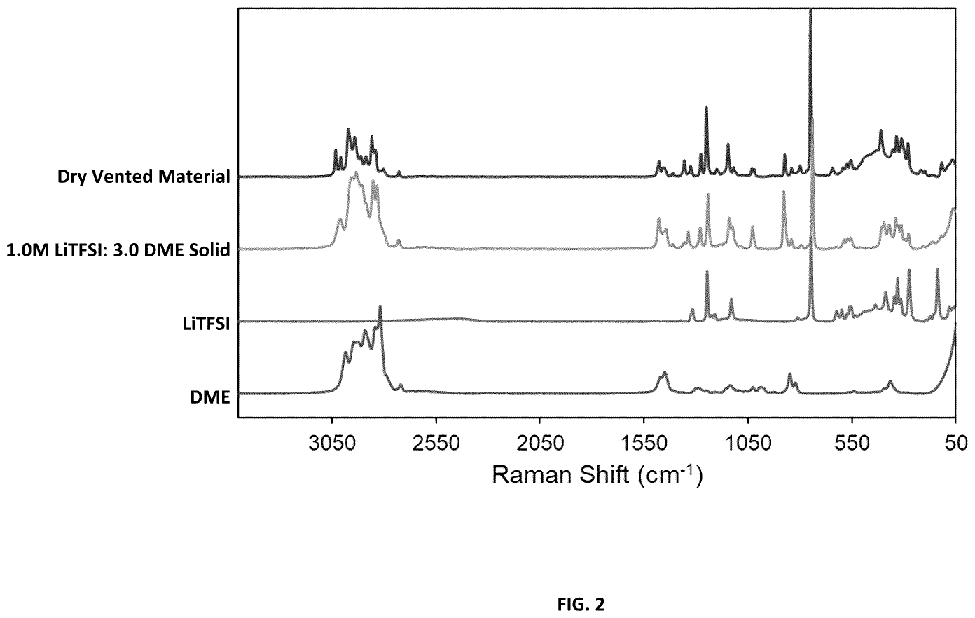

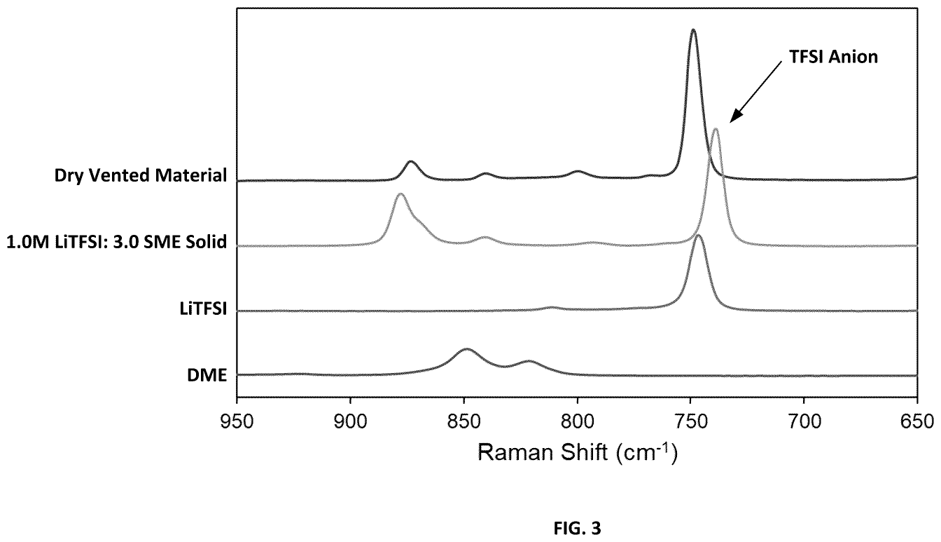

In one example, a liquefied gas electrolyte was produced employing lithium bis(trifluoromethanesulfonyl)imide (LiTFSI) as the salt and dimethoxyethane (DME) as the solidifying agent. DME is a liquid at 100 kPa and 293.15K. In this formulation, the salt and solidifying agent were dissolved in a 1:1 molar ratio within a liquefied gas solvent solution composed of 50% difluoromethane and 50% fluoromethane by molar percent. Upon venting the liquefied gas electrolyte, a white solid material was produced. A Raman spectrum of this solid yielded a spectrum unlike those of both pristine LiTFSI and DME (FIG. 1). To determine the composition of the precipitated material, various mixtures of LiTFSI and DME were produced. A 1:3 molar ratio of LiTFSI and DME was found to produce a solid upon mixing both components at room temperature. The Raman spectrum of the 1:3 LiTFSI:DME solid displayed distinct similarity to those observed in the spectra obtained of the unknown precipitated white material (FIG. 2), though some peaks of the TFSI anion were found to be shifted relative to what would be expected for the 1:3 LiTFSI:DME material (FIG. 3). Further analysis of the melting point (MP) of the precipitated material was found to differ from the reported MP of the 1:3 LiTFSI:DME solid (−49° C. and 29° C. respectively), though an MP of 56° C. was reported for the associated 1:1 LiTFSI:DME solid. As a result, it was surmised that the material deposited upon venting the liquefied gas electrolyte mixture containing a 1:1 LiTFSI and DME was indeed the associated 1:1 LiTFSI:DME solid. Isolation of the 1:1 solid from mixing the associated molar ratio of LiTFSI and DME was attempted but was not successful due to the inability to initially dissolve the LiTFSI in DME at the molar ratios to produce the homogeneous solid. Thus, this discovery also yields a method to create a solid mixture of salts and solidifying agents. This solid mixture of salts and solidifying agents, with the appropriate chemical components, may also be used as an ionically conductive solid electrolyte.

The molar ratio of salt to the solidifying agent within the liquefied gas electrolyte should be such that if forms a solid material upon venting of the liquefied gas solvent from the electrolyte mixture. This molar ratio of salt to solidifying agent can vary depending on the salt and the solidifying agent, but can be 0.1:1, 0.2:1, 0.5:1, 1:1, 1:2, 1:3, 1:4, 1:5. It can be understood that a single solidifying agent may have more than a single coordination site to the salt cation, and so may be used as a guide to determine what an appropriate molar ratio might be. For instance, dimethoxyethane has two oxygens which can coordinate to the salt cation. This strong binding means that one could have a higher molar ratio of 1:3 and still maintain a solid upon venting of the liquefied gas solvent. This might be more beneficial to enhance ionic conductivity or safety of the device. 12-crown-4 has additional coordination sites which may even bind to two cations simultaneously, yielding an even higher molar ratio potential.

The concentration of the salt within the liquefied gas electrolyte may also vary from 0.01M to 25M. The optimized concentration is typically around 1 M which balances cost, conductivity, and temperature range.

In an exemplary electrochemical device using a liquefied gas electrolyte composed of one or more liquefied gas components with any combination of one or more liquid components, one or more solid components, or one or more salt components, the electrodes are composed of any combination of two electrodes of intercalation type such as graphite, carbon, activated carbon, vanadium oxide, lithium titanate, titanium disulfide, molybdenum disulfide, lithium iron phosphate, lithium cobalt phosphate, lithium nickel phosphate, lithium cobalt oxide, lithium nickel manganese oxide, lithium nickel manganese cobalt oxide, lithium nickel cobalt aluminum oxide, carbon, or chemical reaction electrode such as with chemicals of sulfur, oxygen, carbon dioxide, nitrogen, nitrous oxide, sulfur dioxide, thionyl fluoride, thionyl chloride fluoride, sulfuryl fluoride, sulfuryl chloride fluoride or of a metallic electrode with lithium, sodium, magnesium, tin, aluminum, calcium, titanium zinc metal or metal alloy including lithium, sodium, tin, magnesium, aluminum, calcium, titanium, zinc, or any combination thereof. These components may be combined with various binder polymer components, including polyvinylidene fluoride, carboxymethyl cellulose, styrene-butadiene rubber, or polytetrafluoroethylene to maintain structural integrity of the electrode.

In some embodiments, the additives are used in combination with a liquefied gas solvent and lithium, sodium, zinc, calcium, magnesium, aluminum, or titanium-based salts. Further, the one or more liquefied gas solvent solution or electrolyte may be combined with one or more salts, including one or more of lithium bis(trifluoromethanesulfonyl)imide (LiTFSI), lithium hexafluorophosphate (LiPF6), lithium perchlorate (LiClO4), lithium hexafluoroarsenate (LiAsF6), lithium tetrachloroaluminate (LiAlCl4), lithium tetragaliumaluminate, lithium bis(oxalato)borate (LiBOB), lithium hexafluorostannate, lithium difluoro(oxalato)borate (LiDFOB), lithium bis(fluorosulfonyl)imide (LiFSI), lithium aluminum fluoride (LiAlF3), lithium nitrate (LiNO3), lithium chloroaluminate, lithium tetrafluoroborate (LiBF4), lithium tetrachloroaluminate, lithium difluorophosphate, lithium tetrafluoro(oxalato)phosphate, lithium difluorobis(oxalato)phosphate, lithium borate, lithium oxolate, lithium thiocyanate, lithium tetrachlorogallate, lithium chloride, lithium bromide, lithium iodide, lithium carbonate, lithium fluoride, lithium oxide, lithium hydroxide, lithium nitride, lithium super oxide, lithium azide, lithium deltate, di-lithium squarate, lithium croconate dihydrate, dilithium rhodizonate, lithium oxalate, di-lithium ketomalonate, lithium di-ketosuccinate or any corresponding salts with the positive charged lithium cation substituted for sodium or magnesium or any combinations thereof. Further useful salts include those with positively charged cations such as tetramethylammonium, tetraethylammonium, tetrapropylammonium, tetrabutylammonium, triethylmethylammonium ammonium, spiro-(1,1′)-bipyrrolidinium, 1,1-dimethylpyrrolidinium, and 1,1-diethylpyrrolidinium, N,N-diethyl-N-methyl-N(2-methoxyethyl)ammonium, N,N-Diethyl-N-methyl-N-propylammonium, N,N-dimethyl-N-ethyl-N-(3-methoxypropyl)ammonium, N,N-Dimethyl-N-ethyl-N-benzylAmmonium, N,N-Dimethyl-N-ethyl-N-phenylethylammonium, N-Ethyl-N,N-dimethyl-N-(2-methoxyethyl)ammonium, N-Tributyl-N-methylammonium, N-Trimethyl-N-hexylammonium, N-Trimethyl-N-butylammonium, N-Trimethyl-N-propylammonium, 1,3-Dimethylimidazolium, 1-(4-Sulfobutyl)-3-methylimidazolium, 1-Allyl-3H-imidazolium, 1-Butyl-3-methylimidazolium, 1-Ethyl-3-methylimidazolium, 1-Hexyl-3-methylimidazolium, 1-Octyl-3-methylimidazolium, 3-Methyl-1-propylimidazolium, H-3-Methylimidazolium, Trihexyl(tetradecyl)phosphonium, N-Butyl-N-methylpiperidinium, N-Propyl-N-methylpiperidinium, 1-Butyl-1-Methylpyrrolidinium, 1-Methyl-1-(2-methoxyethyl)pyrrolidinium, 1-Methyl-1-(3-methoxypropyl)pyrrolidinium, 1-Methyl-1-octylpyrrolidinium, 1-Methyl-1-pentylpyrrolidinium, or N-methylpyrrolidinium paired with negatively charged anions such as acetate, bis(fluorosulfonyl)imide, bis(oxalate)borate, bis(trifluoromethanesulfonyl)imide, bromide, chloride, dicyanamide, diethyl phosphate, hexafluorophosphate, hydrogen sulfate, iodide, methanesulfonate, methyl-phophonate, tetrachloroaluminate, tetrafluoroborate, and trifluoromethanesulfonate.

One of skill in the art will understand that the terms “one or more salts,” “one or more solvents” (including “liquefied gas solvents”), “one or more solidifying agents”, and “one or more additives,” as used herein in connection with “the ionically conducting electrolytes,” refer to one or a plurality of electrolyte components.

While this document contains many specifics, these should not be construed as limitations on the scope of any invention or of what may be claimed, but rather as descriptions of features that may be specific to a particular embodiment of the invention. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

1. An ionically conducting electrolyte comprising:
a mixture of a liquefied gas solvent, a solidifying agent, and a salt wherein:
the liquefied gas solvent comprises a vapor pressure above 100 kPa at 293.15K;
the solidifying agent is a solid, liquid, or a gas at 100 kPa and 293.15K;
the salt is soluble in the ionically conducting electrolyte at 100 kPa and 293.15K, thereby maintaining the ionically conducting electrolyte in a liquid phase; and
the salt and solidifying agent create a solid material at 100 kPa and 293.15K when the liquified gas solvent is removed from the mixture.

2. The ionically conducting electrolyte of claim 1, wherein the molar concentration of the salt ranges from about 0.01 to about 25 M.

3. The ionically conducting electrolyte of claim 1, wherein the liquefied gas solvent is selected from a group consisting of: dimethyl ether, methyl ethyl ether, fluoromethane, difluoromethane, trifluoromethane, fluoroethane, tetrafluoroethane, pentafluoroethane, 1,1-difluoroethane, 1,2-difluoroethane, 1,1,1-trifluoroethane, 1,1,2-trifluoroethane, 1,1,1,2-tetrafluoroethane, 1,1,2,2-tetrafluoroethane, pentafluoroethane, chloromethane, chloroethane, thionyl fluoride, thionyl chloride fluoride, phosphoryl fluoride, phosphoryl chloride fluoride, sulfuryl fluoride, sulfuryl chloride fluoride, 1-fluoropropane, 2-fluoropropane, 1,1-difluoropropane, 1,2-difluoropropane, 2,2-fluoropropane, 1,1,1-trifluoropropane, 1,1,2-trifluoropropane, 1,2,2-trifluoropropane, fluoroethylene, cis-1,2-fluoroethylene, 1,1-fluoroethylene, 1-fluoropropylene, 2-propylene, chlorine, chloromethane, bromine, iodine, ammonia, methyl amine, dimethyl amine, trimethyl amine, molecular oxygen, molecular nitrogen, carbon monoxide, carbon dioxide, sulfur dioxide, methyl vinyl ether, difluoro ethylene, nitrous oxide, nitrogen dioxide, nitrogen oxide, carbon disulfide, hydrogen fluoride, hydrogen chloride or any combination thereof.

4. The ionically conducting electrolyte of claim 1, wherein the solidifying agent is selected from the group consisting of: dimethoxyethane, bis(2-methoxyethyl)ether, 1,2-bis(2-methoxyethoxy)ethane, 12-crown-4, 15-cown-5, 18-crown-6, diphenyl sulfone, bis(4-fluorophenyl) sulfone, dimethyl sulfone, ethyl methyl sulfone, butadiene sulfone, 1,3-propanesultone, 1-propene-1,3-sultone, 2-bornanone, 2,3-borananedione, 2-norbornanone, triphenyl phosphate, ethylene carbonate, or any combination thereof.

5. The ionically conducting electrolyte of claim 1, wherein the salt is selected from a group consisting of: LiTFSI, LiFSI, LiPF₆, LiBOB, LiBF₄, LiDFOB, LiNO₃, or any combination thereof.

6. An electrochemical device comprising:
the ionically conducting electrolyte of claim 1;
a positive first electrode and a negative second electrode in contact with the ionically conducting electrolyte; and
a housing enclosing the ionically conducting electrolyte, the first electrode and second electrode.

7. The electrochemical device of claim 6, wherein one of the electrodes is selected from a group consisting of: graphite, carbon, activated carbon, vanadium oxide, and lithium titanate, titanium disulfide, molybdenum disulfide, lithium iron phosphate, lithium cobalt phosphate, lithium nickel phosphate, lithium cobalt oxide, lithium nickel manganese oxide, lithium nickel manganese cobalt oxide, and lithium nickel cobalt aluminum oxide.

8. The electrochemical device of claim 6, wherein one of the electrodes is selected from a group consisting of: lithium metal, sodium metal, calcium metal, magnesium metal, aluminum metal, and zinc metal.

9. The electrochemical device of claim 6, wherein the electrochemical device is a lithium battery.
